(19) United States
(12) Patent Application Publication
(10) Pub. No.: US 2018/0217446 A1
(43) Pub. Date: Aug. 2, 2018

(54) LOCAL DIMMING BACKLIGHT MODULES AND DISPLAY DEVICES

(71) Applicant: Yongyuan QIU, Shenzhen, Guangdong (CN)

(72) Inventor: Yongyuan QIU, Shenzhen, Guangdong (CN)

(73) Assignee: Shenzhen China Star Optoelectronics Technology Co., Ltd., Shenzhen, Guangdong (CN)

(21) Appl. No.: 15/327,342

(22) PCT Filed: Dec. 29, 2016
(86) PCT No.: PCT/CN2016/113102

§ 371 Date: Jan. 18, 2017

(30) Foreign Application Priority Data
Dec. 6, 2016 (CN) 201611106535.2

(51) Int. Cl. G02F 1/1335; H05B 33/08

(52) U.S. Cl. CPC G02F 1/133603; G02F 1/133526; G02F 1/133606; H05B 33/0845

(57) ABSTRACT

The present disclosure relates to a local dimming backlight module including: a back plate having at least one reflective surface configured as an internal surface, a LED light source component arranged on the back plate, an optical film set facing toward the LED light source, the LED light source component includes a light source arranged in a matrix and a secondary lens arranged above the light source; the back plate is divided into a plurality of areas, a bar-shaped reflective component is configured in a rim of the light source of at least one area; and the reflective component includes at least one set of adjacent reflective surfaces, and the at least one set of adjacent reflective surfaces intersect with each other to form the secondary lenses facing toward edges of one area of the back plate.

### BACKGROUND OF THE INVENTION

### 1. Field of the Invention

The present disclosure relates to display technology, and more particularly to a local dimming backlight module and a display device.

### 2. Discussion of the Related Art

Liquid crystal devices (LCDs) are main display devices being an interface between users and information. The LCDs are characterized by attributes such as high space utilization rate, low power consumption, and low electromagnetic interference, and have been widely adopted by devices such as televisions, cellular phones, and tablets.

High-dynamic range (HDR) images having more display details have been proposed along with a high display performance of LCDs. To realize higher contrast, a local dimming concept has been proposed, that is, a backlight including hundreds of LEDs replaces a backlight lamp. The backlight LED may be adjusted in accordance with the brightness of the images. The brightest portion of the display images may be the greatest, and the brightness of the dark portion may be lowered down, or even shut down so as to obtain optimal brightness. In this way, the power consumption of the backlight module may be reduced by lowering down the brightness of the dark portion.

Currently, with respect to direct-lit backlight modules, usually, lens design is adopted. The beam angle may be increased to enhance the light-mixing effect and to decrease the number of the LEDs by adopting secondary lens. However, with respect to local dimming design, when the beam angle is increased, the performance of the local dimming area may be bad. As a result, it is a critical issue of implementing the HDR products with fewer LED local dimming demand.

### SUMMARY

The present disclosure relates to a local dimming backlight module and a display device. In one aspect, a local dimming backlight module includes: a back plate having at least one reflective surface configured as an internal surface, a LED light source component arranged on the back plate, an optical film set facing toward the LED light source, the LED light source component includes a light source arranged in a matrix and a secondary lens arranged above the light source; the back plate is divided into a plurality of areas, a bar-shaped reflective component is configured in a rim of the light source of at least one area; and the reflective component includes at least one set of adjacent reflective surfaces, and the at least one set of adjacent reflective surfaces intersect with each other to form the secondary lenses facing toward edges of one area of the back plate.

Wherein a top of the secondary lens is configured as a V-shaped recessed notch.

Wherein each of lateral sides of the V-shaped recessed notch includes a plurality of saw-tooth recessions.

Wherein a density of the saw-tooth recessions is gradually increased along a direction from a central portion of the V-shaped recessed notch to the two lateral sides.

Wherein the top of the secondary lens is the reflective surface.

Wherein the reflective component includes at least one first reflective component in a first area of the back plate, the first reflective component includes two sets of back-to-back reflective surfaces, and the two sets of the back-to-back reflective surface form a prism.

Wherein the first reflective components surround the first area.

Wherein the back plate includes a bottom plate for fixing the LED light source component and side plates surrounding edges of the bottom plate; the back plate further includes at least one second reflective component in a second area of the back plate, the second area is configured in a rim of the back plate, and the second reflective component includes two reflective surfaces respectively connecting to the bottom plate and the side plate.

Wherein the reflective component includes a third reflective component arranged in the first area of the back plate, the third reflective component includes two sets of back-to-back reflective surfaces, and the two sets of the reflective surfaces of the first reflective component and the back plate cooperatively form a pentagon.

In another aspect, a display device includes: a local dimming backlight module includes a back plate having at least one reflective surface configured as an internal surface, a LED light source component arranged on the back plate, an optical film set facing toward the LED light source, the LED light source component includes a light source arranged in a matrix and a secondary lens arranged above the light source; the back plate is divided into a plurality of areas, a bar-shaped reflective component is configured in a rim of the light source of at least one area; and the reflective component includes at least one set of adjacent reflective surfaces, and the at least one set of adjacent reflective surfaces intersect with each other to form the secondary lenses facing toward edges of one area of the back plate.

Wherein a top of the secondary lens is configured as a V-shaped recessed notch.

Wherein each of lateral sides of the V-shaped recessed notch includes a plurality of saw-tooth recessions.

Wherein a density of the saw-tooth recessions is gradually increased along a direction from a central portion of the V-shaped recessed notch to the two lateral sides.

Wherein the top of the secondary lens is the reflective surface.

Wherein the reflective component includes at least one first reflective component in a first area of the back plate, the first reflective component includes two sets of back-to-back reflective surfaces, and the two sets of the back-to-back reflective surface form a prism.

Wherein the first reflective components surround the first area.

Wherein the back plate includes a bottom plate for fixing the LED light source component and side plates surrounding edges of the bottom plate; the back plate further includes at least one second reflective component in a second area of the back plate, the second area is configured in a rim of the back plate, and the second reflective component includes two reflective surfaces respectively connecting to the bottom plate and the side plate.

Wherein the reflective component includes a third reflective component arranged in the first area of the back plate, the third reflective component includes two sets of back-to-back reflective surfaces, and the two sets of the reflective surfaces of the first reflective component and the back plate cooperatively form a pentagon.

Wherein the top of the secondary lens is the reflective surface.

In another aspect, a display device includes: a local dimming backlight module includes a back plate having at least one reflective surface configured as an internal surface, a LED light source component arranged on the back plate, an optical film set facing toward the LED light source, the LED light source component includes a light source arranged in a matrix and a secondary lens arranged above the light source; the back plate is divided into a plurality of areas, a bar-shaped reflective component is configured in a rim of the light source of at least one area; the reflective component includes at least one set of adjacent reflective surfaces, and the at least one set of adjacent reflective surfaces intersect with each other to form the secondary lenses facing toward edges of one area of the back plate; a top of the secondary lens is configured as a V-shaped recessed notch, each of lateral sides of the V-shaped recessed notch includes a plurality of saw-tooth recessions, a density of the saw-tooth recessions is gradually increased along a direction from a central portion of the V-shaped recessed notch to the two lateral sides; and wherein the reflective component includes at least one first reflective component in a first area of the back plate, the first reflective component includes two sets of back-to-back reflective surfaces, and the two sets of the back-to-back reflective surface form a prism.

In view of the above, the LED light source and the secondary lens are configured on the back plate. The reflective components having adjacent reflective surfaces are configured in accordance with the LED light source component and the secondary lens. The local dimming effect with respect to a specific area may be realized due to the optical characteristics of the secondary lens and the rebound characteristics of the optical path of the reflective components. Not only may the optical performance be ensured, but also the product competitiveness.

### BRIEF DESCRIPTION OF THE DRAWINGS

FIG. 1 is a schematic view of a central area of a backlight module in accordance with a first embodiment.

FIG. 2 is a schematic view of an edge area of a backlight module in accordance with the first embodiment.

FIG. 3 is a partial view of the backlight module in accordance with the first embodiment.

FIG. 4 is a schematic view of the central area of the backlight module in accordance with the second embodiment.

FIG. 5 is a schematic view of the edge area of the backlight module in accordance with the second embodiment.

### DETAILED DESCRIPTION OF THE EMBODIMENTS

Embodiments of the invention will now be described more fully hereinafter with reference to the accompanying drawings, in which embodiments of the invention are shown.

The display device includes a local dimming backlight module for providing better optical performance of the display panel. The backlight module includes a back plate having an internal surface as a reflective surface, a LED component arranged on the back plate, and an optical film set facing toward the LED component. The LED component includes a light source arranged in a matrix and a secondary lens arranged above the light source. The back plate is divided into a plurality of area. At least one of the areas is configured with a bar-shaped light reflection component arranged in a rim of the light source. The light reflection component includes at least one set of adjacent reflective surfaces intersecting with each other to form prism edges of the of lenses on the edges of one of the areas, that is, the secondary lenses in one row or in one column face toward the edges of one of the areas.

### First Embodiment

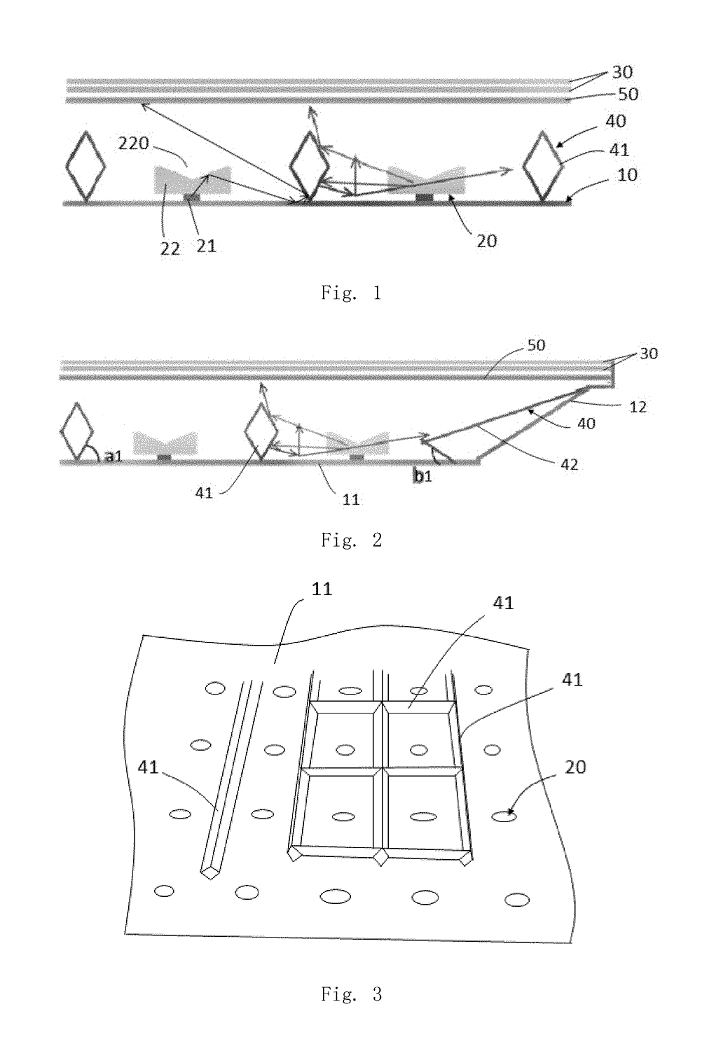

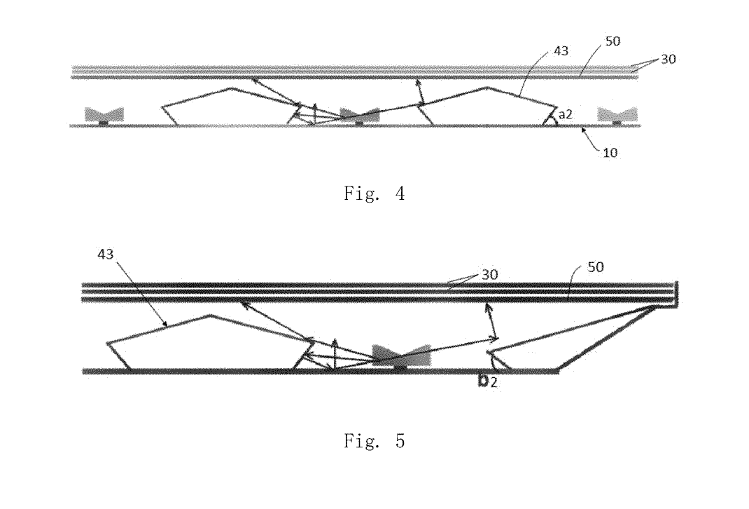

Referring to FIG. 1, the backlight module includes a back plate 10, a LED light source component 20, an optical film set 30 spaced apart from the LED light source component 20, and at least one reflective component 40 arranged in a rim of the LED light source component 20. Referring to FIGS. 2 and 3, the back plate 10 is configured to fix a bottom plate 11 of the LED light source component 20 and side plates 12 surrounding edges of the bottom plate 11, and an included angle formed by the side plate 12 and the bottom plate 11 is an obtuse angle. Internal surfaces of the bottom plate 11 and the side plate 12 of the back plate 10 are reflective surfaces, that is, the surfaces of the back plate 10 are coated with a layer of reflective material or a reflective layer is adhered to the surfaces of the back plate 10.

The LED light source component 20 includes a light source 21 arranged in a matrix and a secondary lens 22 arranged above the light source 21. The bottom plate 11 of the back plate 10 is divided into a plurality of areas, the light source 21 of a portion of the areas is configured with a reflective component 40. A top of the secondary lens 22 is configured with the reflective surface. Specifically, the top of the secondary lens 22 is configured as a V-shaped recessed notch 220. In one embodiment, each of the lateral sides of the V-shaped recessed notch 220 includes a plurality of saw-tooth recessions, and a density of the saw-tooth recessions is gradually increased along a direction from a central portion of the V-shaped recessed notch 220 to two lateral sides such that light beams from the light source 21 passing through the V-shaped recessed notch 220 are reflected in an obliquely downward direction. A portion of the light beams reflected by the bottom plate 11 arrive a light emitting surface, a portion of the light beams reflected by the bottom plate 11 arrive the reflective component 40, a portion of the light beams directly radiate the reflective component 40. The light beams arriving the reflective component 40 emit out from the light emitting surface after being reflected such that the light beams are optimized. Due to above configuration of the saw-tooth recessions of each of the lateral sides of the V-shaped recessed notch 220, the light beams reflected by the top of the secondary lens 22 are in an uniform distribution.

In the embodiment, the reflective component 40 includes at least one first reflective component 41 in a first area and a second reflective component 42 in a second area. The first reflective component 41 includes two sets of back-to-back reflective surfaces. The two sets of the back-to-back reflective surfaces of the first reflective component 41 form a prism, that is, a cross section of the reflective component 40 along a direction perpendicular to a length direction is prism-shaped. The reflective components 40 surround the first area, as shown in FIG. 3. The second area is the area in a rim of the back plate 10, and the first area is the area facing away sidewalls of the back plate 10. The second reflective component 42 includes two reflective surfaces respectively connecting to the bottom plate 11 and the side plate 12. A free end of the reflective surface of the second reflective component 42 connecting to the side plate 12 completely wraps the side plate 12 until reaching a fixing end of the optical film set 30. Here, the reflective component 40 is a hollow and white plastic frame, which may be easily fixed and the weight is light.

Further, a diffusion plate 50 is arranged in a back side of the optical film set 30. After passing through the diffusion plate 50, the light beams toward the optical film set 30 are uniformly distributed.

As shown in FIG. 2, in the embodiment, the included angle (al) formed by the two reflective surfaces of the first reflective component 41 in the bottom and the bottom plate 11 is greater than 50 degrees. Preferably, the included angle is 57 degrees. A height and a width of each of the reflective surfaces of the first reflective component 41 is 7 mm regardless of the vertical direction or the horizontal direction. The included angle formed by the reflective surfaces of the second reflective component 42 in the bottom and the bottom plate 11 is smaller than 45 degrees, and the reflective surfaces in the bottom face toward the central portion of the bottom plate 11. In the embodiment, the backlight module may be adopted by display devices having a higher local-dimming precision. The dimension of the local-dimming area is about 50 mm*50 mm.

In addition, the reflective component 40 may be fixed by different methods in accordance with the areas where it is arranged. For instance, the reflective component 40 may be fixed by adhesive or screws when the reflective component 40 may be easily fixed. Alternatively, the reflective component 40 may be fixed by clasps when the reflective component 40 may not be easily fixed on locations, such as edges.

### Second Embodiment

As shown in FIGS. 4 and 5, the difference between the first embodiment and the second embodiment resides in that: the reflective component 40 includes a third reflective component 43 arranged in the first area (which is not an edge area) of the back plate 10 and a second reflective component 42 arranged in the second area (which is the edge area) of the back plate 10. The third reflective component 43 includes two sets of the back-to-back reflective surfaces. The two sets of the reflective surface of the first reflective component 41 and the back plate 10 cooperatively form a pentagon. That is, the two reflective surfaces of the third reflective component 43 in the bottom have not intersected with each other. The two reflective surface of the third reflective component 43 in the bottom are spaced apart from each other. The included angle formed by the third reflective component 43 and the bottom plate 11 is smaller than 45 degrees, and the included angle formed by the reflective surface of the second reflective component 42 in the bottom and the bottom plate 11 is smaller than 45 degrees. Preferably, the included angle formed by the third reflective component 43 and the bottom plate 11 is the same with the included angle formed by the reflective surface of the second reflective component 42 in the bottom and the bottom plate 11. In the embodiment, the dimension of the local dimming area is greater than that in the first embodiment, that is, the dimension of the local dimming area is greater than 100 mm*100 mm, and thus the precision of the second embodiment may be a little bit decreased.

The shape of the reflective component 40 may be configured in accordance with real scenarios, ad may be configured according to the location of the local dimming area. For instance, with respect to the portion having a smaller local dimming area, the first reflective component 41 and the second reflective component 42 in the first embodiment may be adopted. With respect to the portion having a larger local dimming area, the second reflective component 42 and the third reflective component 43 in the second embodiment may be adopted.

In view of the above, the LED light source and the secondary lens are configured on the back plate. The reflective components having adjacent reflective surfaces are configured in accordance with the LED light source component and the secondary lens. The local dimming effect with respect to a specific area may be realized due to the optical characteristics of the secondary lens and the rebound characteristics of the optical path of the reflective components. Not only the optical performance may be ensured, but also the product competitiveness.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A local dimming backlight module, comprising:
a back plate having at least one reflective surface configured as an internal surface, a LED light source component arranged on the back plate, an optical film set facing toward the LED light source, the LED light source component comprises a light source arranged in a matrix and a secondary lens arranged above the light source;
the back plate is divided into a plurality of areas, a bar-shaped reflective component is configured in a rim of the light source of at least one area; and
the reflective component comprises at least one set of adjacent reflective surfaces, and the at least one set of adjacent reflective surfaces intersect with each other to form the secondary lenses facing toward edges of one area of the back plate.

2. The backlight module as claimed in claim 1, wherein a top of the secondary lens is configured as a V-shaped recessed notch.

3. The backlight module as claimed in claim 2, wherein each of lateral sides of the V-shaped recessed notch comprises a plurality of saw-tooth recessions.

4. The backlight module as claimed in claim 3, wherein a density of the saw-tooth recessions is gradually increased along a direction from a central portion of the V-shaped recessed notch to the two lateral sides.

5. The backlight module as claimed in claim 2, wherein the top of the secondary lens is the reflective surface.

6. The backlight module as claimed in claim 5, wherein the reflective component comprises at least one first reflective component in a first area of the back plate, the first reflective component comprises two sets of back-to-back reflective surfaces, and the two sets of the back-to-back reflective surface form a prism.

7. The backlight module as claimed in claim 6, wherein the first reflective components surround the first area.

8. The backlight module as claimed in claim 5, wherein the back plate comprises a bottom plate for fixing the LED light source component and side plates surrounding edges of the bottom plate;
the back plate further comprises at least one second reflective component in a second area of the back plate, the second area is configured in a rim of the back plate, and the second reflective component comprises two reflective surfaces respectively connecting to the bottom plate and the side plate.

9. The backlight module as claimed in claim 5, wherein the reflective component comprises a third reflective component arranged in the first area of the back plate, the third reflective component comprises two sets of back-to-back reflective surfaces, and the two sets of the reflective surfaces of the first reflective component and the back plate cooperatively form a pentagon.

10. A display device, comprising:
a local dimming backlight module comprises a back plate having at least one reflective surface configured as an internal surface, a LED light source component arranged on the back plate, an optical film set facing toward the LED light source, the LED light source component comprises a light source arranged in a matrix and a secondary lens arranged above the light source;
the back plate is divided into a plurality of areas, a bar-shaped reflective component is configured in a rim of the light source of at least one area; and
the reflective component comprises at least one set of adjacent reflective surfaces, and the at least one set of adjacent reflective surfaces intersect with each other to form the secondary lenses facing toward edges of one area of the back plate.

11. The display device as claimed in claim 10, wherein a top of the secondary lens is configured as a V-shaped recessed notch.

12. The display device as claimed in claim 11, wherein each of lateral sides of the V-shaped recessed notch comprises a plurality of saw-tooth recessions.

13. The display device as claimed in claim 12, wherein a density of the saw-tooth recessions is gradually increased along a direction from a central portion of the V-shaped recessed notch to the two lateral sides.

14. The display device as claimed in claim 11, wherein the top of the secondary lens is the reflective surface.

15. The display device as claimed in claim 14, wherein the reflective component comprises at least one first reflective component in a first area of the back plate, the first reflective component comprises two sets of back-to-back reflective surfaces, and the two sets of the back-to-back reflective surface form a prism.

16. The display device as claimed in claim 15, wherein the first reflective components surround the first area.

17. The display device as claimed in claim 14, wherein the back plate comprises a bottom plate for fixing the LED light source component and side plates surrounding edges of the bottom plate;
the back plate further comprises at least one second reflective component in a second area of the back plate, the second area is configured in a rim of the back plate, and the second reflective component comprises two reflective surfaces respectively connecting to the bottom plate and the side plate.

18. The display device as claimed in claim 14, wherein the reflective component comprises a third reflective component arranged in the first area of the back plate, the third reflective component comprises two sets of back-to-back reflective surfaces, and the two sets of the reflective surfaces of the first reflective component and the back plate cooperatively form a pentagon.

19. The display device as claimed in claim 12, wherein the top of the secondary lens is the reflective surface.

20. A display device, comprising:
a local dimming backlight module comprises a back plate having at least one reflective surface configured as an internal surface, a LED light source component arranged on the back plate, an optical film set facing toward the LED light source, the LED light source component comprises a light source arranged in a matrix and a secondary lens arranged above the light source;
the back plate is divided into a plurality of areas, a bar-shaped reflective component is configured in a rim of the light source of at least one area;
the reflective component comprises at least one set of adjacent reflective surfaces, and the at least one set of adjacent reflective surfaces intersect with each other to form the secondary lenses facing toward edges of one area of the back plate;
a top of the secondary lens is configured as a V-shaped recessed notch, each of lateral sides of the V-shaped recessed notch comprises a plurality of saw-tooth recessions, a density of the saw-tooth recessions is gradually increased along a direction from a central portion of the V-shaped recessed notch to the two lateral sides; and
wherein the reflective component comprises at least one first reflective component in a first area of the back plate, the first reflective component comprises two sets of back-to-back reflective surfaces, and the two sets of the back-to-back reflective surface form a prism.
